(19) United States
(12) Patent Application Publication
(10) Pub. No.: US 2021/0031638 A1
(43) Pub. Date: Feb. 4, 2021

(54) Mobile Charging Station with Battery Storage for Electric Vehicles

(71) Applicant: Lightning Systems, Inc., Loveland, CO (US)

(72) Inventors: Keith Lehmeier, Fort Collins, CO (US); Michael Corona, Fort Collins, CO (US); Tyler Yadon, Fort Collins, CO (US); William Briggs, Greeley, CO (US)

(73) Assignee: Lightning Systems, Inc., Loveland, CO (US)

(21) Appl. No.: 16/868,236

(22) Filed: May 6, 2020

Related U.S. Application Data
(60) Provisional application No. 62/844,525, filed on May 7, 2019.

(51) Int. Cl. B60L 53/10; H02J 7/00; B60L 53/53; B60L 58/24; B60L 53/60; H01M 10/44; H01M 10/623

(52) U.S. Cl. CPC B60L 53/11; H02J 7/007; H02J 7/0045; B60L 53/53; B60L 58/24; B60L 2210/10; H01M 10/44; H01M 10/623; H02J 2207/20; B60L 2210/30; B60L 53/60

(57) ABSTRACT

A mobile charging station with battery storage for electric vehicles is provided. In one embodiment, a mobile charging station receives a continuous Level 2 charge, converts the continuous Level 2 charge to an intermittent Direct Current Fast Charge (DCFC), and provides the intermittent Direct Current Fast Charge (DCFC) to an electric vehicle for charging. In another embodiment, the mobile charging station has a plurality of charging inputs and charging outputs and provides charge received from one of the plurality of charging inputs to one of the plurality of charging outputs. In yet another embodiment, the mobile charging station is mobile but not integrated in any one vehicle. Other embodiments are provided.

### CROSS-REFERENCE TO RELATED APPLICATION

This application claims the benefit of U.S. Patent Application No. 62/844,525, filed May 7, 2019, which is hereby incorporated by reference.

### BACKGROUND

Commercial electric vehicles (EVs) require charging rates much higher than consumer EVs due to the much larger battery packs (to support the additional vehicle weight) but have a maintained requirement to be able to charge overnight. In most cases, this requires a charging system known as DC Fast Charge (DCFC) to meet these charging rates. DCFC requires extensively more power grid infrastructure (480VAC-3P in most cases), which is not only costly but also takes up to a year in some cases to get the required permitting. However, the grid infrastructure required to support lower charging levels (commonly referred to as “Level-I” or “Level-II” charging) does not suffer from either of these circumstances.

### BRIEF DESCRIPTION OF THE DRAWINGS

FIG. 1 is an illustration of an embodiment of MBVC power flow with no input charging.

FIG. 2 is an illustration of an embodiment of MBVC power flow with Level 1 no input charging.

FIG. 3 is an illustration of an embodiment of MBVC power flow with Level 2 no input charging.

FIG. 4 is a block diagram of a mobile charging station of an embodiment.

FIG. 5 is a block diagram of a mobile charging station of an embodiment.

FIG. 6 is a flow chart of an embodiment showing main control states.

FIG. 7 is a flow chart of an embodiment showing no request logic.

FIG. 8 is a flow chart of an embodiment showing input power active logic.

FIG. 9 is a flow chart of an embodiment showing output power active logic.

FIG. 10 is a flow chart of an embodiment showing input and output power active logic.

FIG. 11 is a block diagram of a mobile charging station of an embodiment.

FIG. 12 is a block diagram of a mobile charging station of an embodiment showing cooling lines.

FIG. 13 is a block diagram of a mobile charging station of an embodiment showing control lines.

FIG. 14 is a block diagram of a mobile charging station of an embodiment showing high voltage lines.

FIG. 15 is an illustration of a stationary charging system of an embodiment.

FIG. 16 is an illustration of a stationary charging system of an embodiment.

FIG. 17 is an illustration of a stationary charging system of an embodiment.

FIG. 18 is an illustration of a stationary charging system of an embodiment.

FIG. 19 is an illustration of a stationary charging system of an embodiment being transported by a cargo van

FIG. 20 is an illustration of mobile charger configurations of an embodiment.

FIG. 21 is an illustration of a first input configuration (AC (Level II)) of an embodiment.

FIG. 22 is an illustration of a second input configuration (DCFC) of an embodiment.

FIG. 23 is an illustration of a first output configuration (AC/DC Converter) of an embodiment.

FIG. 24 is an illustration of a second output configuration (DCFC) of an embodiment.

FIG. 25 is an illustration of a third output configuration (DC/DC Converter) of an embodiment.

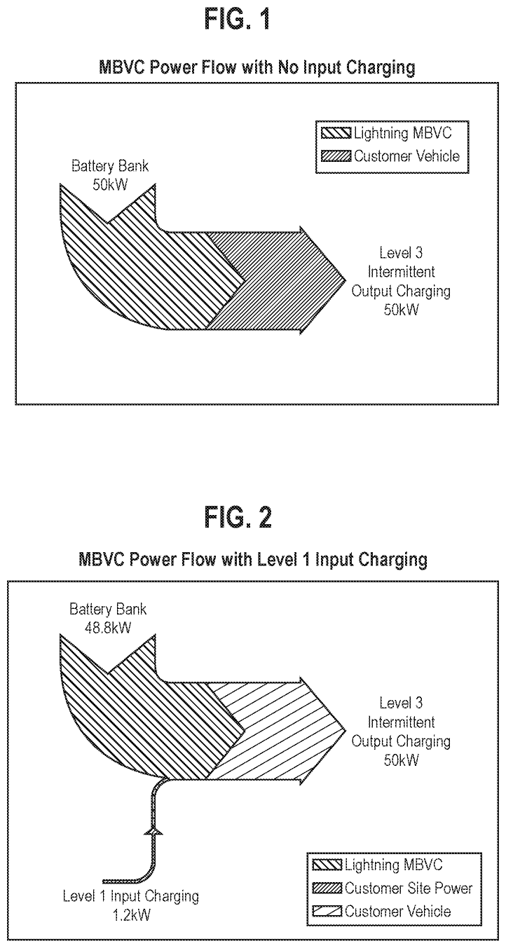

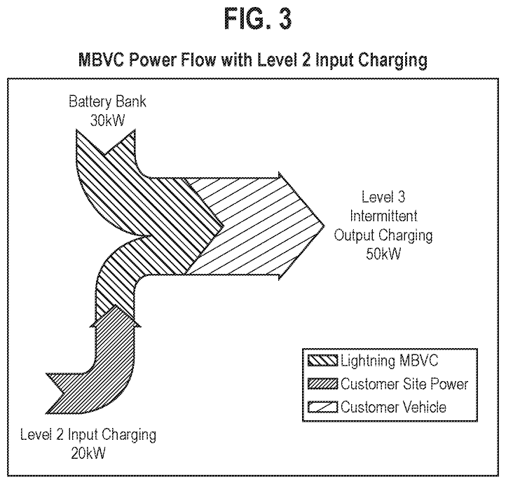

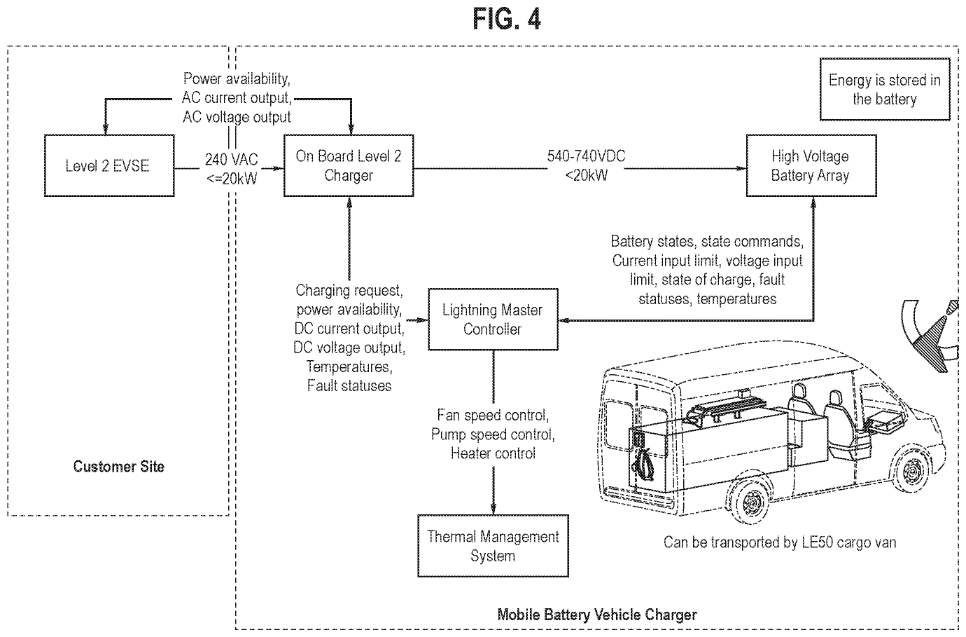

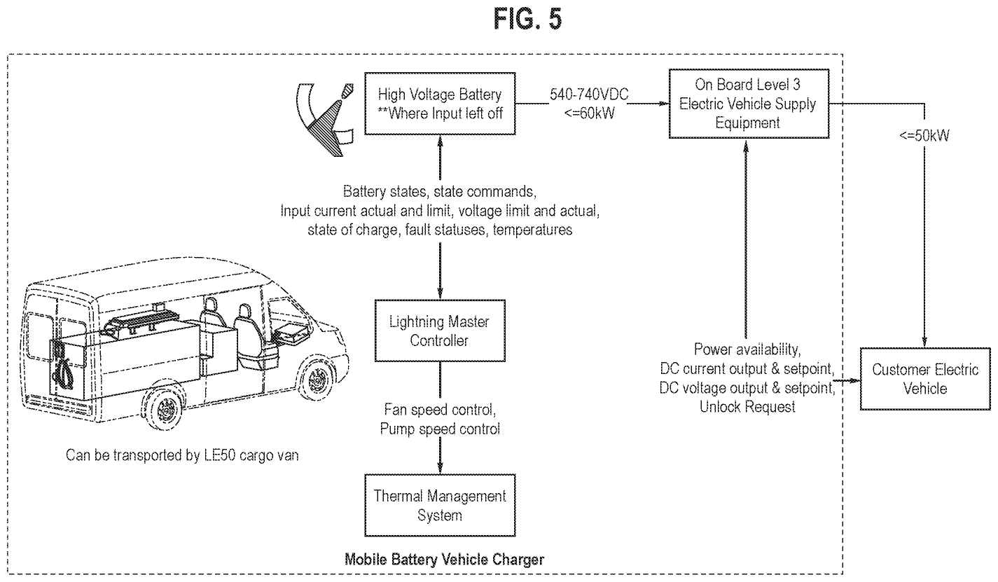

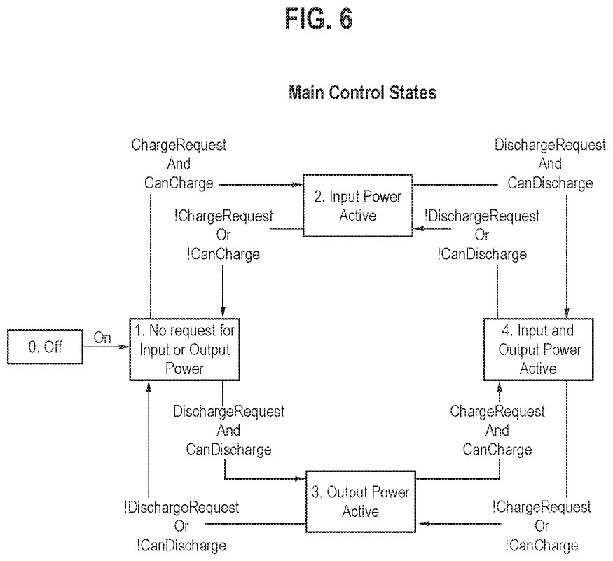

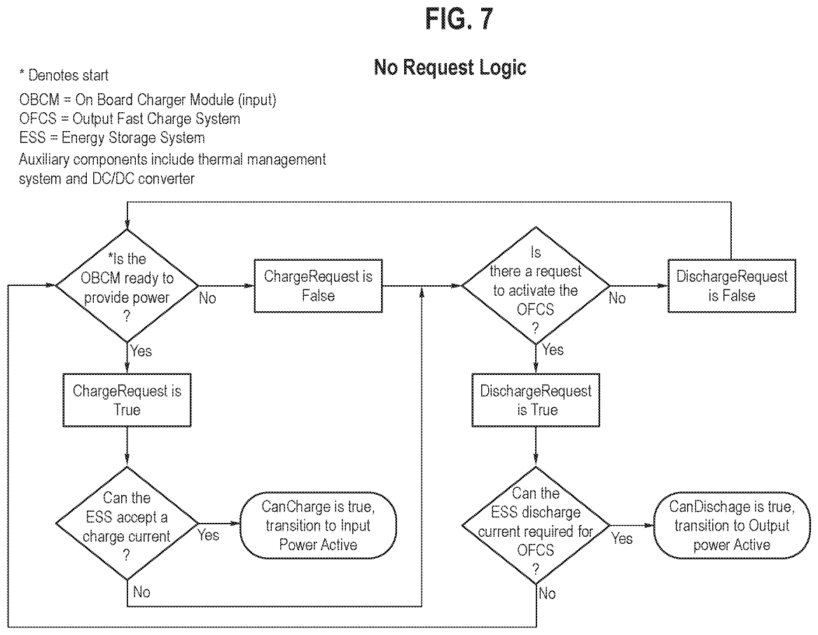

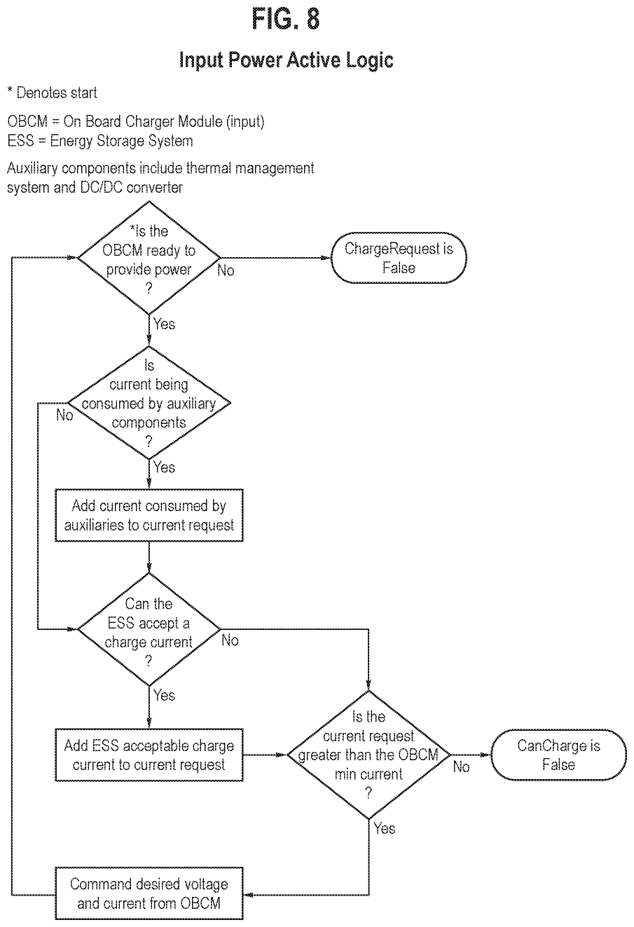

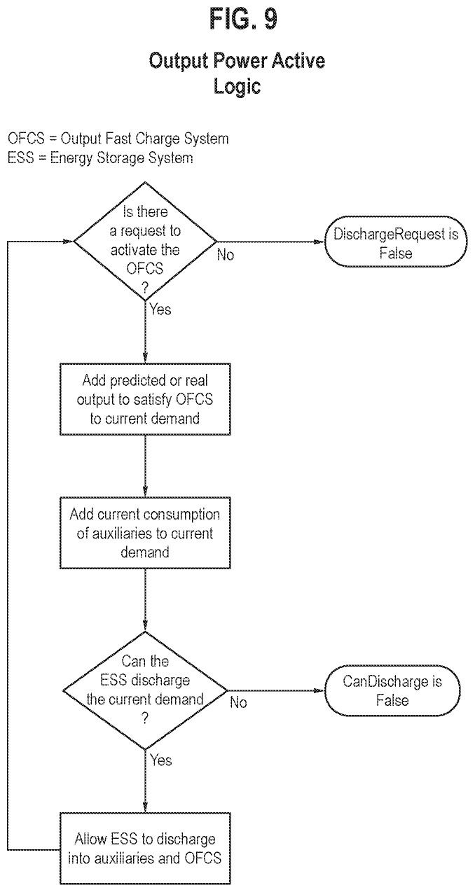

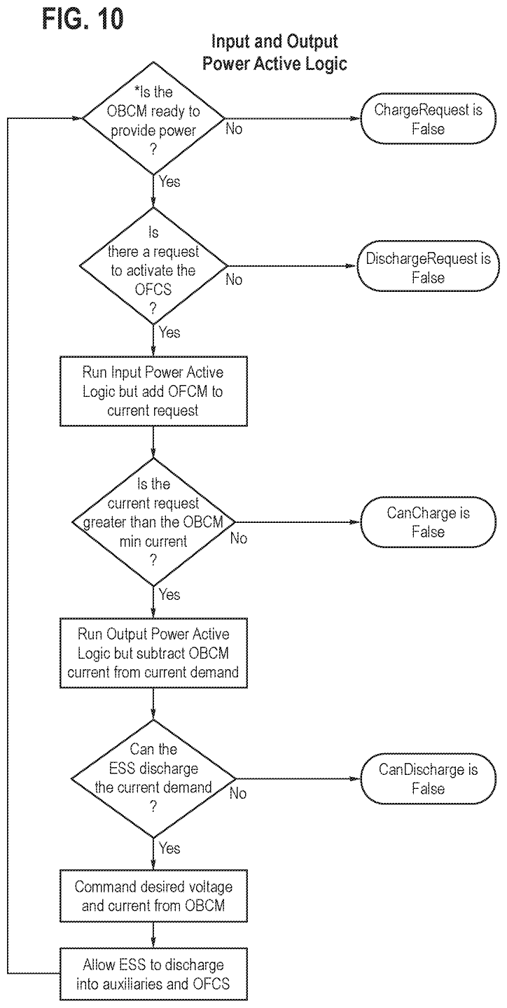

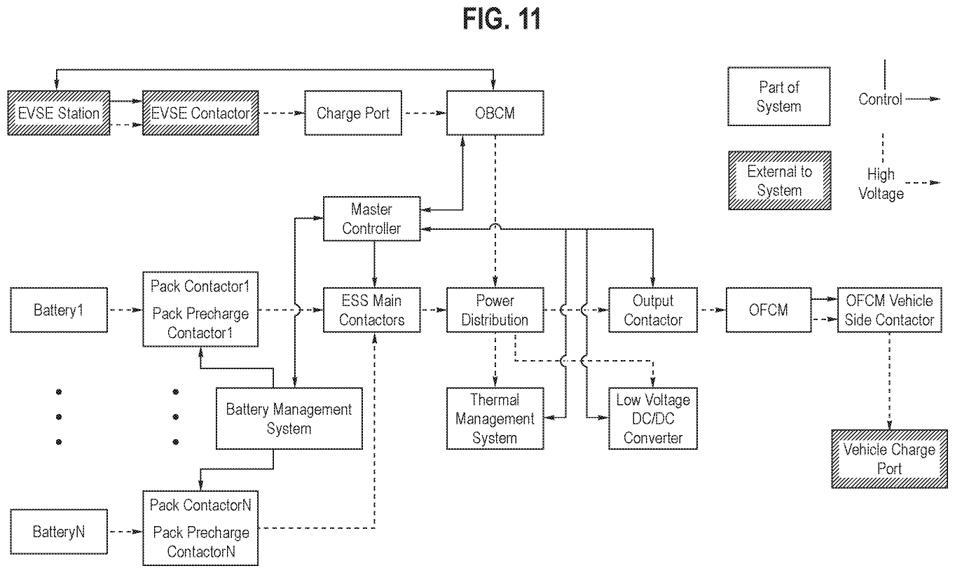

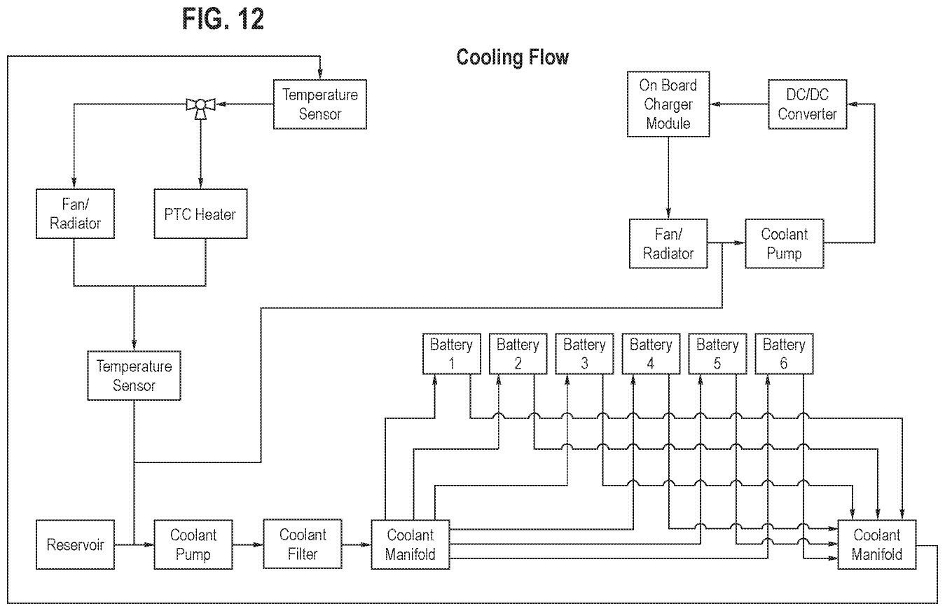

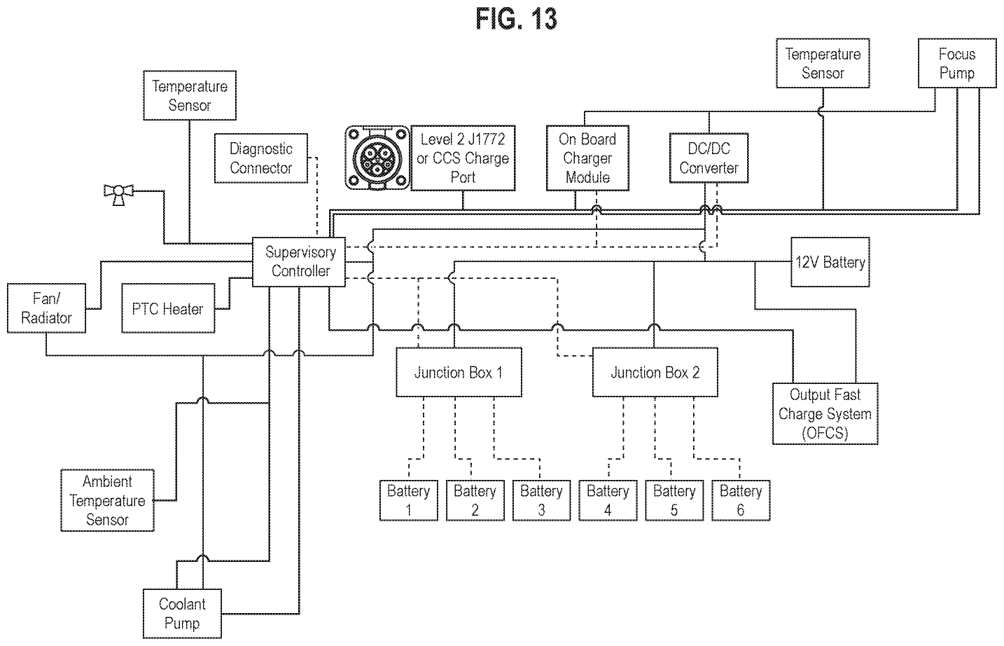

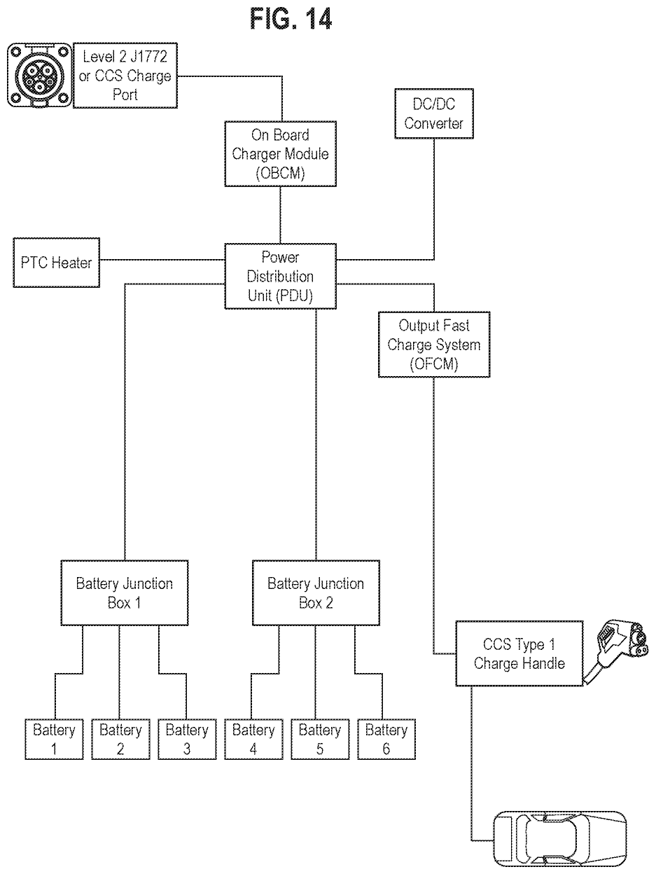

### DETAILED DESCRIPTION

The following embodiments provide a mobile charging station with battery storage for electric vehicles that can be utilized to “up-convert” Level-II charging stations to dispense DCFC charging rates (50-350 kW) in intervals. Additionally, the mobile charging station of these embodiments can be charged remotely, driven to the vehicles needing charge, and then depleted of its battery system to charge the vehicles. Other uses of the mobile charging station can be made.

The mobile charging station of these embodiments can have the following characteristics/capabilities:

Level 2 to DCFC conversion

Can be charged with EVSE (Level I, II, DCFC)

Street legal mobile

Can provide AC grid power (110/220)

Isolated V2MG (feed power TO AC outlet in the event of a power outage)

In one embodiment, the mobile charging station comprises five (5) major components: the Energy Storage System (ESS), the thermal management system, the EV charging system, the station charging system, and the controls system.

The Energy Storage System (ESS) comprises a system of discrete battery packs that are connected either in parallel or in series. The system comprises battery modules, junction boxes, power distribution modules, and power electronics. This system is the core of the system, storing energy received from the station charging system and providing energy to the EV charging system. The ESS is thermally managed (heating and cooling) by the thermal management system.

The thermal management system is responsible for keeping the ESS in a temperature range that prolongs life and enhances performance. It is a system that is capable of both heating and cooling the liquid that is then distributed by pumps throughout the system.

The EV charging system is responsible for delivering stored energy from the ESS to the EV(s) being charged. This is accomplished through either a J1772-CCS or CHAdeMO interface. The charging is considered DCFC as the capable power level is a minimum of 50 kW.

The station charging system is responsible for receiving energy from the electrical grid or other power source and delivering this energy to the ESS so it can be stored. This is accomplished through either a J1772-CCS or CHAdeMO interface. The charging is considered DCFC as the capable power level is a minimum of 50 kW, but the station can also be charged with level-1 or level-2 charging (1-20 kW).

The control system is responsible for operating the other four (4) main systems, as well as the user interface. Some examples include: determining cooling needed and adjusting actuators and systems accordingly, conducting station-to-EV communication protocol(s) to facilitate safe and fast charging, and determining and setting the appropriate voltage levels for charging, via the power electronics.

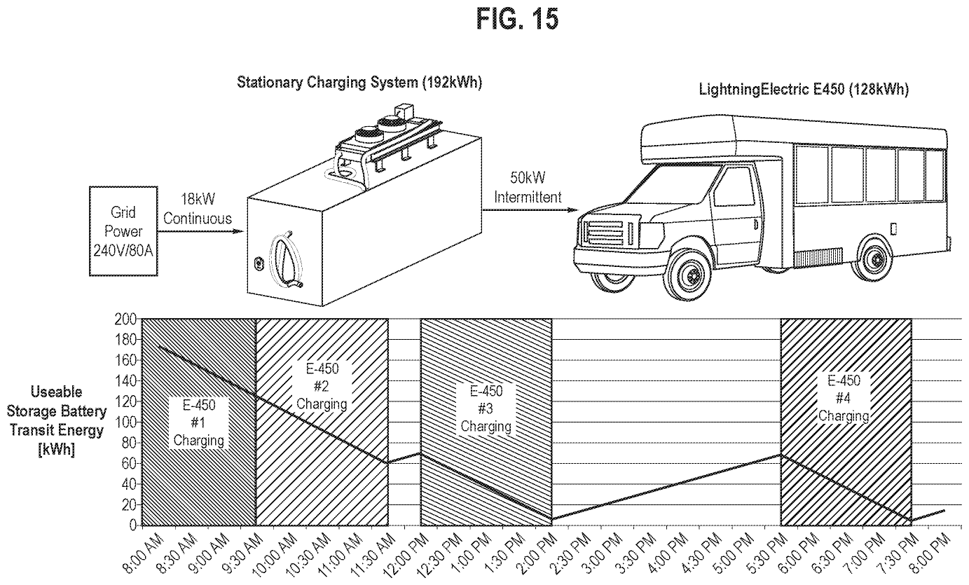

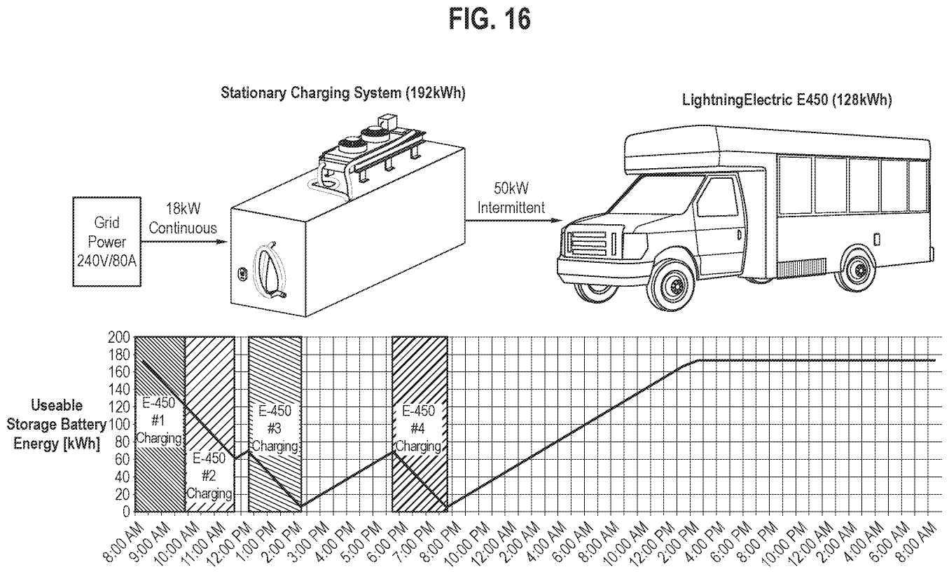

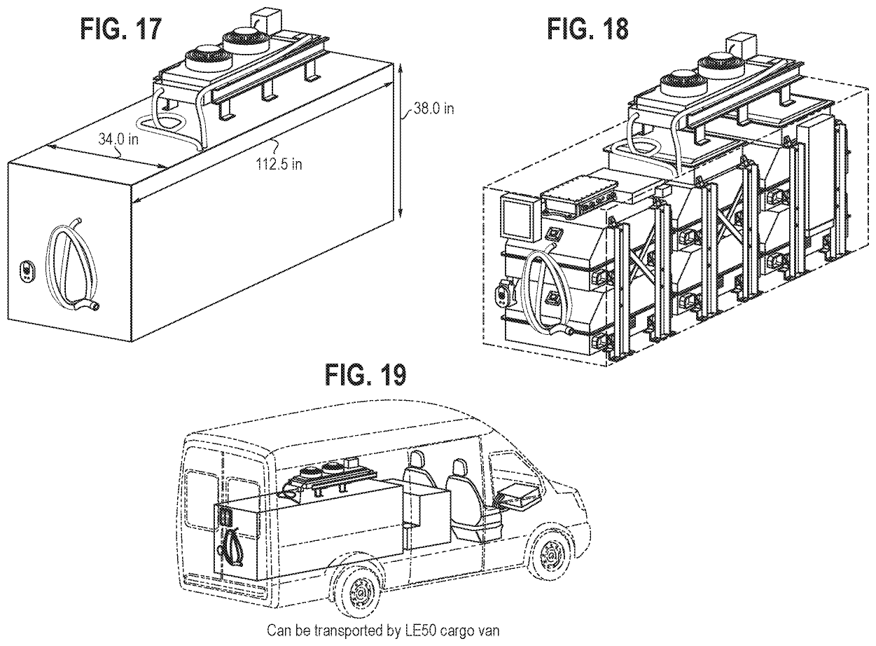

FIGS. 15-19 provide additional information. FIGS. 15-18 are illustrations of a stationary charging system of an embodiment, and FIG. 19 shows a stationary charging system of an embodiment being transported by a cargo van

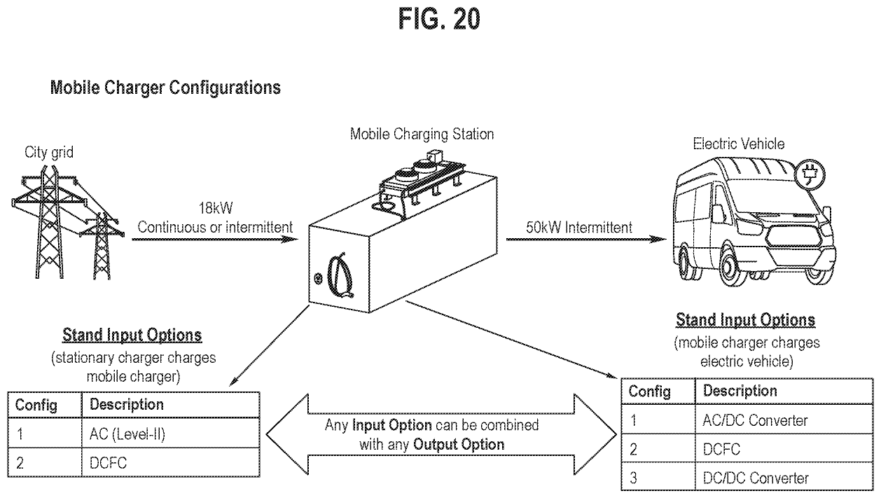

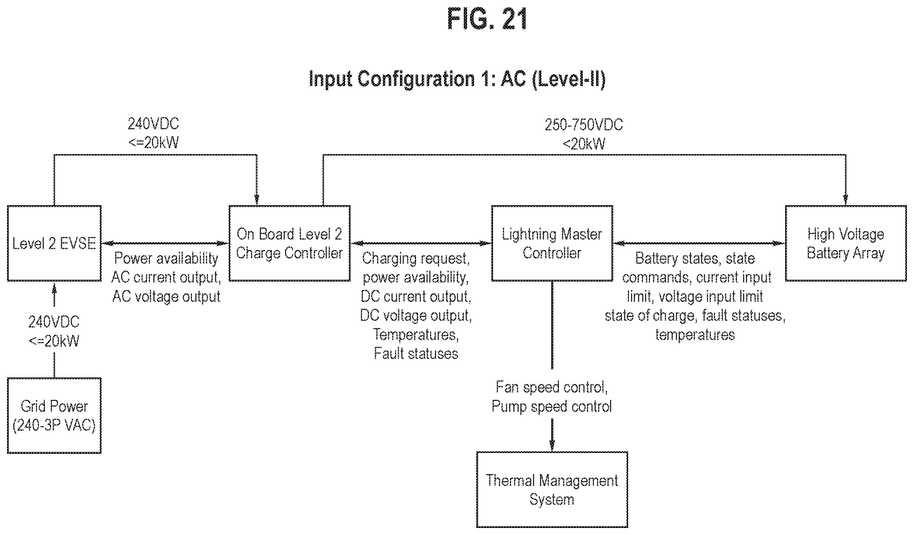

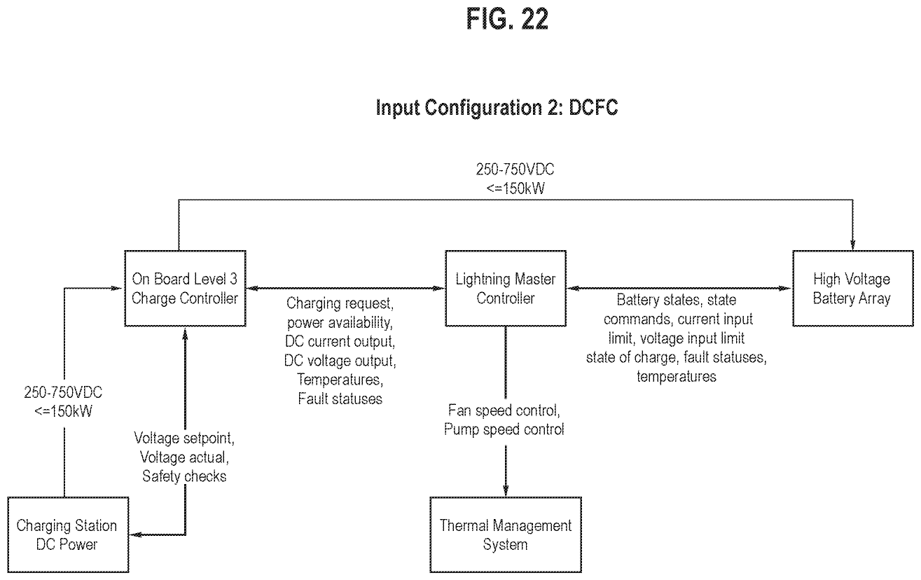

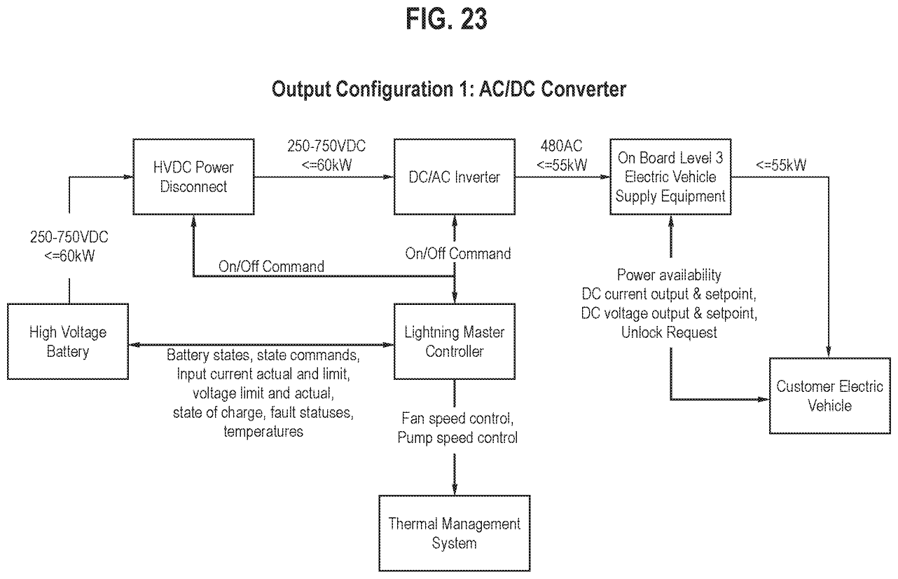

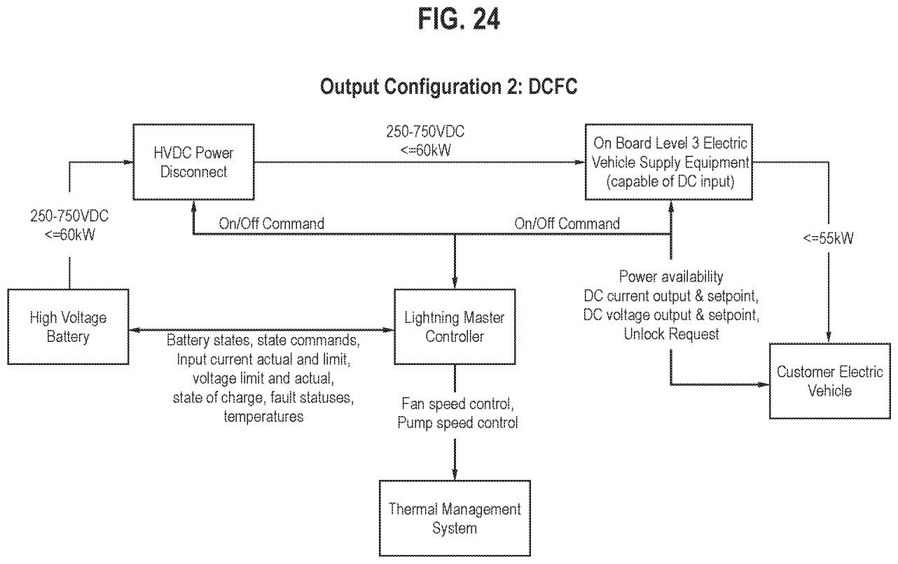

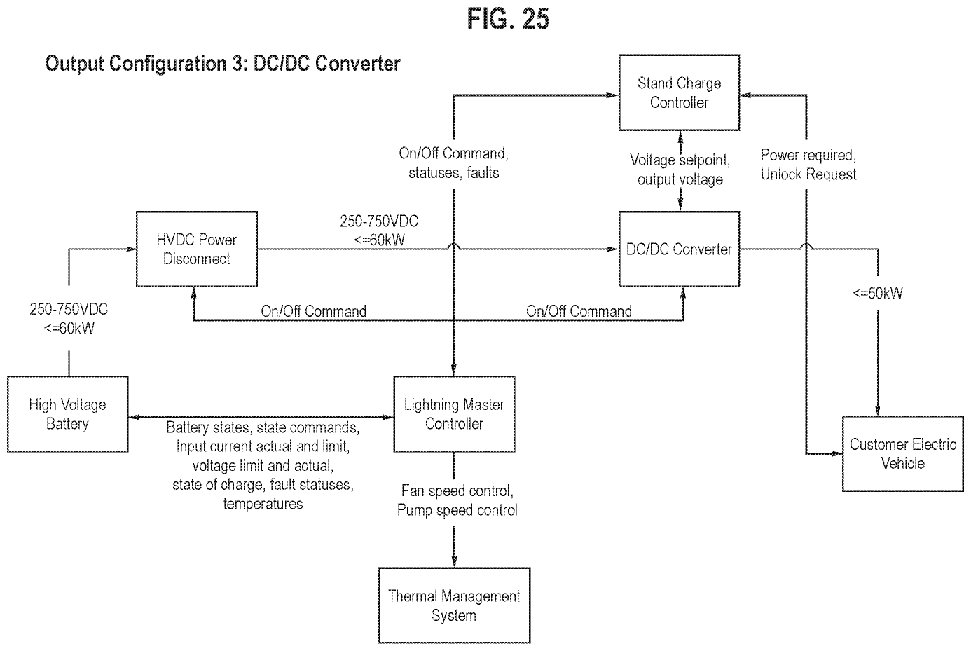

In one embodiment, the mobile charging station has the ability to be architected in three (3) different ways. These different architectures have differing impacts on cost, performance, and availability, but at the core all accomplish the same goals with respect to up-converting Level-II charging to DCFC. FIGS. 20-25 illustrate these architectures. FIG. 20 is an illustration of mobile charger configurations of an embodiment. FIG. 21 is an illustration of a first input configuration (AC (Level II)) of an embodiment. FIG. 22 is an illustration of a second input configuration (DCFC) of an embodiment. FIG. 23 is an illustration of a first output configuration (AC/DC Converter) of an embodiment. FIG. 24 is an illustration of a second output configuration (DCFC) of an embodiment. FIG. 25 is an illustration of a third output configuration (DC/DC Converter) of an embodiment.

There are several advantages associated with these embodiments. For example:

the ability to recharge EVs in remote sites where charging infrastructure may not exist

the ability to rescue EVs that have depleted battery systems on roadways

providing a mechanism for energy arbitrage/peak-shaving

the ability to provide emergency off-shore power (110, 220 VAC)

providing energy storage for V2G and V2H applications

the ability to convert CC 1.0 (50 kW) to CCS 2.0 (350 kW)

In general, the mobile charging station of these embodiments provides many different use cases, many of which may be required by the same end user(s). Current mobile chargers do not support DC Fast Charging and are not self-propelled. These embodiments can also use second-life vehicle batteries when their state of health has deteriorated too far to be used in vehicles.

The attached figures show various possible implementations of these embodiments. In general, the functionality of the mobile charging station can be provided by one or more controllers or processors that are configured to implement the algorithms shown in the attached drawings and described herein. As used herein, a controller or processor can take the form of processing circuitry, a microprocessor or processor, and a computer-readable medium that stores computer-readable program code (e.g., firmware) executable by the (micro)processor, logic gates, switches, an application specific integrated circuit (ASIC), a programmable logic controller, and an embedded microcontroller, for example. Additionally, the phrase “in communication with” could mean directly in communication with or indirectly (wired or wireless) in communication with through one or more components, which may or may not be shown or described herein. The term “module” may also be used herein. A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

1. (canceled)

2. A mobile charging station comprising:
an input configured to receive a continuous Level 2 charge;
a converter configured to convert the continuous Level 2 charge to an intermittent Direct Current Fast Charge (DCFC); and
an output configured to provide the intermittent Direct Current Fast Charge (DCFC) to an electric vehicle for charging.

3. The mobile charging station of claim 2, wherein one or both of the input and output comprises a J1772-CCS interface.

4. The mobile charging station of claim 2, wherein one or both of the input and output comprises a CHAdeMO interface.

5. The mobile charging station of claim 2, further comprising an energy storage system comprising a battery and configured to store the continuous Level 2 charge received from the input as energy in the battery.

6. The mobile charging station of claim 5, further comprising a station charging system configured to receive the continuous Level 2 charge via the input and provide it to the energy storage system for storage.

7. The mobile charging station of claim 5, further comprising an electrical vehicle charging system configured to deliver stored energy from the energy storage system to the electrical vehicle via the output.

8. The mobile charging station of claim 5, further comprising a thermal management system configured to keep the energy storage system in a predetermined temperature range.

9. The mobile charging station of claim 2, further comprising a control system configured to control the mobile charging station.

10. A mobile charging station comprising:
a plurality of charging inputs;
a plurality of charging outputs; and
a controller configured to provide charge received from one of the plurality of charging inputs to one of the plurality of charging outputs.

11. The mobile charging station of claim 10, wherein the plurality of charging inputs comprise one or more of the following: a Level 2 charge and a Direct Current Fast Charge (DCFC).

12. The mobile charging station of claim 10, wherein the plurality of charging outputs comprise one or more of the following: an alternating current/direct current (AC/DC) converter, a Direct Current Fast Charge (DCFC), and a direct current/direct current (DC/DC) converter.

13. The mobile charging station of claim 10, further comprising an energy storage system comprising a battery and configured to store charge received from one of the plurality of inputs as energy in the battery.

14. The mobile charging station of claim 13, further comprising a station charging system configured to receive the charge via one of the plurality of charging inputs and provide it to the energy storage system for storage.

15. The mobile charging station of claim 13, further comprising an electrical vehicle charging system configured to deliver stored energy from the energy storage system to an electrical vehicle for charging via one of the plurality of charging outputs.

16. The mobile charging station of claim 13, further comprising a thermal management system configured to keep the energy storage system in a predetermined temperature range.

17. The mobile charging station of claim 10, further comprising a control system configured to control the mobile charging station.

18. A mobile charging station comprising:
an input configured to accept a charge;
a battery configured to store the charge; and
an output configured to provide the stored charge to an electric vehicle for charging;
wherein the mobile charging station is mobile but not integrated in any one vehicle.

19. The mobile charging station of claim 18, wherein the input is configured to receive a continuous Level 2 charge, wherein the mobile charging station further comprises a converter configured to convert the continuous Level 2 charge to an intermittent Direct Current Fast Charge (DCFC), and wherein the output is configured to provide the intermittent Direct Current Fast Charge (DCFC) to the electric vehicle.

20. The mobile charging station of claim 18, wherein the input comprises a plurality of charging inputs, wherein the output comprises a plurality of charging outputs, and wherein the mobile charging station further comprises a controller configured to provide charge received from one of the plurality of charging inputs to one of the plurality of charging outputs.

21. The mobile charging station of claim 20, wherein the plurality of charging inputs comprise one or more of the following: a Level 2 charge and a Direct Current Fast Charge (DCFC), and wherein the plurality of charging outputs comprise one or more of the following: an alternating current/direct current (AC/DC) converter, a Direct Current Fast Charge (DCFC), and a direct current/direct current (DC/DC) converter.
